(19) United States
(12) Patent Application Publication
(10) Pub. No.: US 2026/0056785 A1
(43) Pub. Date: Feb. 26, 2026

(54) ELECTRONIC DEVICE FOR LOADING RESOURCE AND RESOURCE LOADING METHOD USING THE SAME

(71) Applicant: SAMSUNG ELECTRONICS CO., LTD., Suwon-si (KR)

(72) Inventors: Sujae JO, Suwon-si (KR); Sungsik Park, Suwon-si (KR); Jinwoo Kwon, Suwon-si (KR); Nayoung Kim, Suwon-si (KR); Soogyeom Kim, Suwon-si (KR)

(73) Assignee: SAMSUNG ELECTRONICS CO., LTD., Suwon-si (KR)

(21) Appl. No.: 19/289,904

(22) Filed: Aug. 4, 2025

Related U.S. Application Data
(63) Continuation of application No. PCT/KR2025/010764, filed on Jul. 22, 2025.

(30) Foreign Application Priority Data
Aug. 22, 2024 (KR) 10-2024-0112800

(51) Int. Cl. G06F 9/50

(52) U.S. Cl. CPC G06F 9/5022; G06F 9/5016; G06F 9/5038

(57) ABSTRACT

An electronic device includes memory storing one or more instructions; and at least one processor operatively coupled to the memory, in which the one or more instructions, when executed by the at least one processor, may cause the electronic device to: download, through a network, a plurality of resources associated with a first web service, store, from the plurality of resources, a first resource in a disk cache, generate, from the plurality of resources, a cache miss list for a second resource not stored in the disk cache, load the first resource from the disk cache based on reusing the first web service, and load, through the network, the second resource included in the cache miss list based on reusing the first web service.

### CROSS-REFERENCE TO RELATED APPLICATIONS

This application is a by-pass continuation application of International Application No. PCT/KR2025/010764, filed on Jul. 22, 2025, which is based on and claims priority to Korean Patent Application No. 10-2024-0112800, filed on Aug. 22, 2024, in the Korean Intellectual Property Office, the disclosures of which are incorporated by reference herein in their entireties.

### BACKGROUND

### 1. Field

The disclosure relates to loading a resource through a network, and more particularly, to an electronic device for loading a resource in a web service through a network and a resource loading method using the same.

### 2. Description of Related Art

As network communication technology including the Internet rapidly develops, web services that provide multimedia contents, such as text and video, are developing in various forms. A user who wishes to receive a web service may access a web server via the Internet using a web browser. The web server may provide a web service or a web page created in a web language, such as hypertext markup language (HTML).

The web browser may download various resources, such as HTML, CSS, JavaScript files, images, fonts, audios, and videos, required when first accessing the web service. For example, some of the resources may be stored in a disk cache and, when needed later, the same resources may be quickly loaded from the disk cache.

However, the disk cache has limited capacity and may not be able to store resources under certain conditions. For example, if the disk cache is low on free space, or if the file size or format of a specific resource is not suitable for the disk cache, the specific resource may not be stored in the disk cache.

If the specific resource is not stored in the disk cache, whenever the web service is used, the specific resource is re-downloaded over the network, resulting in longer loading times and increased network traffic.

### SUMMARY

Various embodiments of the disclosure may provide an electronic device providing a fast response to a user and minimizing network requests required for a web service by managing resources not stored in a disk cache as a cache miss list and loading the resources in an idle time, and a resource loading method using the same.

According to an aspect of the disclosure, an electronic device loading a resource includes memory storing one or more instructions; and at least one processor operatively coupled to the memory, in which the one or more instructions, when executed by the at least one processor, may cause the electronic device to: download, through a network, a plurality of resources associated with a first web service, store, from the plurality of resources, a first resource in a disk cache, generate, from the plurality of resources, a cache miss list for a second resource not stored in the disk cache, load the first resource from the disk cache based on reusing the first web service, and load, through the network, the second resource included in the cache miss list based on reusing the first web service.

The second resource may be loaded through the network independently of the start or completion of loading the first resource.

The second resource may be loaded during an idle time before the first web service is reused independently of the loading of the first resource.

The one or more instructions, when executed by the at least one processor, may cause the electronic device to: simultaneously with the loading the first resource, generate a separate thread to load the second resource.

The one or more instructions, when executed by the at least one processor, may cause the electronic device to: provide the first web service using the first resource and the second resource.

The one or more instructions, when executed by the at least one processor, may cause the electronic device to: identify that a free capacity of the disk cache is a threshold capacity or less, and determine that the second resource is a resource not stored in the disk cache based on at least one of a resource size or a resource format of the second resource.

The one or more instructions, when executed by the at least one processor, may cause the electronic device to: store, in the disk cache, at least one of a uniform resource locator (URL), a file size, a file format, cache control information, a validity period, or a last modified date of the first resource.

The cache miss list may include at least one of a uniform resource locator (URL), a validity period, a request time, a request count, a request order, a cache header, cache control information, or server information of the second resource.

The one or more instructions, when executed by the at least one processor, may cause the electronic device to: identify that the first web service is reused, and load the second resource included in the cache miss list at an idle time based on determining that a CPU usage is less than or equal to a reference usage.

The one or more instructions, when executed by the at least one processor, may cause the electronic device to: load the second resource from the cache miss list through a separate thread independently from a process of loading the first resource from the disk cache.

The one or more instructions, when executed by the at least one processor, may cause the electronic device to: reduce a network burden resulting from loading of the second resource by setting a loading priority of the second resource to a threshold priority or lower based on at least one of a validity period, a request time, a request count, or a request order of the second resource.

The one or more instructions, when executed by the at least one processor, may cause the electronic device to: perform a validity check on the second resource included in the cache miss list based on reusing the first web service, and in which the validity check includes identifying at least one of a validity period, an E-tag, a last modified date, or cache control information of the second resource.

The one or more instructions, when executed by the at least one processor, may cause the electronic device to: determine whether a validity period of the second resource is expired, and delete from the cache miss list the second resource whose validity period is expired.

The one or more instructions, when executed the at least one processor, may cause the electronic device to: based on the second resource being deleted from the cache miss list, download the second resource again through the network based on reusing the first web service to update the cache miss list.

According to an aspect of the disclosure, a method performed by at least one processor of an electronic device for loading a resource may include: downloading, through a network, a plurality of resources associated with a first web service; storing, from the plurality of resources, a first resource in a disk cache; generating, from the plurality of resources, a cache miss list for a second resource not stored in the disk cache; loading the first resource from the disk cache based on reusing the first web service; and loading, through the network, the second resource included in the cache miss list based on reusing the first web service.

The generating the cache miss list for the second resource may include: identifying that a free capacity of the disk cache is a threshold capacity or less; and determining that the second resource is a resource not stored in the disk cache based on at least one of a resource size or a resource format of the second resource.

The storing the first resource in the disk cache may comprise storing, in the disk cache, at least one of a uniform resource locator (URL), a file size, a file format, cache control information, a validity period, or a last modified date of the first resource.

The cache miss list may comprise at least one of a uniform resource locator (URL), a validity period, a request time, a request count, a request order, a cache header, cache control information, or server information of the second resource.

The loading the second resource included in the cache miss list through the network may include: identifying that the first web service is reused; and loading the second resource included in the cache miss list at an idle time based on determining that a CPU usage is less than or equal to a reference usage.

The loading the second resource included in the cache miss list through the network may comprise loading the second resource from the cache miss list through a separate thread independently from a process of loading the first resource from the disk cache.

The loading the second resource included in the cache miss list through the network may comprise reducing a network burden resulting from loading of the second resource by setting a loading priority of the second resource to a threshold priority or lower based on at least one of a validity period, a request time, a request count, or a request order of the second resource.

The loading the second resource included in the cache miss list through the network may comprise performing a validity check on the second resource included in the cache miss list based on reusing the first web service, and wherein the validity check includes identifying at least one of a validity period, an E-tag, a last modified date, or cache control information of the second resource.

The method may further include: determining whether a validity period of the second resource is expired; and deleting from the cache miss list the second resource whose validity period is expired.

The method may further include, based on the second resource being deleted from the cache miss list, downloading the second resource again through the network based on reusing the first web service to update the cache miss list.

According to an embodiment, the electronic device and the resource loading method using the same may manage resources not stored in the disk cache as a cache miss list and preload the resources in an idle time, thereby optimizing or improving the loading performance of a web service. According to an embodiment, the electronic device and the resource loading method using the same may minimize or reduce network requests required for a web service and provide a fast response to a user.

Effects achievable in example embodiments of the disclosure are not limited to the above-mentioned effects, but other effects not mentioned may be apparently derived and understood by one of ordinary skill in the art to which example embodiments of the disclosure pertain, from the following description. In other words, unintended effects in practicing embodiments of the disclosure may also be derived by one of ordinary skill in the art from example embodiments of the disclosure.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view illustrating a network environment including an electronic device according to one or more embodiments;

FIG. 2 is a block diagram illustrating a function-specific configuration of an electronic device according to one or more embodiments;

FIG. 3 is a block diagram illustrating an example configuration of an electronic device according to one or more embodiments;

FIG. 4 is a flowchart illustrating operations of an electronic device according to one or more embodiments;

FIG. 5 is an example view illustrating a resource information table received by an electronic device according to one or more embodiments;

FIG. 6 is a view illustrating a method for storing a cacheable resource by an electronic device according to one or more embodiments;

FIG. 7 is a view illustrating a process of loading a web service by an electronic device according to one or more embodiments; and

FIGS. 8A and 8B are views illustrating comparison between web service loading times by an electronic device according to one or more embodiments.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, no description is made of well-known functions and configurations in the drawings and relevant descriptions.

It should be appreciated that the blocks in each flowchart and combinations of the flowcharts may be performed by computer program instructions.

Further, each block may represent a module, an engine, a segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions. The terms “module” or “engine” may refer to one or more instructions executed by a processor to perform one or more functions. The terms “module” or “engine” may also refer to circuitry configured to perform the one or more functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more packet processing devices. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and/or variables. Functions provided within the components and the ‘units’ may be combined into smaller numbers of components and ‘units’ or further separated into additional components and ‘units’. Further, an element or a ‘unit’ may be implemented to reproduce one or more central processing units (CPUs) in a device or a security multimedia card. According to embodiments, a “ . . . unit” may include one or more packet processing devices.

According to one or more embodiments, an electronic device as disclosed herein may be a device with a communication function. For example, examples of the electronic device may include, but is not limited to, a smartphone, a tablet PC, a mobile phone, a video phone, an e-book reader, a desktop PC (personal computer), a laptop computer, a netbook computer, a PDA (personal digital assistant), a PMP (portable multimedia player), an MP3 player, a mobile medical device, a camera, or a wearable device (e.g., a head-mounted device (HMD), electronic clothes, an electronic bracelet, an electronic necklace, an electronic appcessory, an electronic tattoo, or a smart watch).

According to one or more embodiments, the electronic device may be a smart home appliance with communication capabilities.

For example, examples of the smart home appliance may include, but is not limited to, a television, a digital video disk (DVD) player, an audio player, a refrigerator, an air conditioner, a vacuum cleaner, an oven, a microwave oven, a washer, a drier, an air cleaner, a set-top box, a TV box (e.g., Samsung HomeSync™, Apple TV™, or Google TV™), a gaming console, an electronic dictionary, a camcorder, or an electronic picture frame.

According to one or more embodiments, examples of the electronic device may include, but is not limited to, various medical devices (e.g., magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, an sailing electronic device (e.g., a sailing navigation device, a gyroscope, or a compass), avionics, security devices, vehicular head units, industrial or home robots, automatic teller's machines (ATMs), or point of sales (POS) devices.

According to one or more embodiments, examples of the electronic device may include, but is not limited to, a piece of furniture or part of a building/structure having a communication function, an electronic board, an electronic signature receiving device, a projector, or various measurement devices (e.g., devices for measuring water, electricity, gas, or electromagnetic waves). According to an embodiment of the disclosure, the electronic device may be one or a combination of the above-listed devices or appliances. According to an embodiment of the disclosure, the electronic device may be a flexible device. According to an embodiment of the disclosure, the electronic device is not limited to the above-listed devices or appliances.

Various embodiments of the disclosure are now described with reference to the accompanying drawings. As used herein, the term “user” may denote a human or another device using the electronic device.

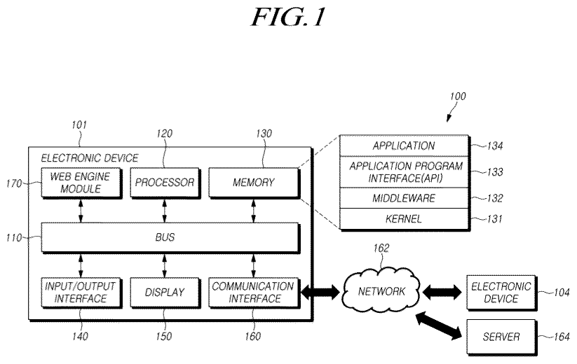

FIG. 1 illustrates a network environment 100 including an electronic device 101 according to one or more embodiments.

In FIG. 1, the electronic device 101 may include a bus 110, a processor 120, memory 130, an input/output interface 140, a display 150, a communication interface 160, and/or a web engine module 170.

The bus 110 connects the other components to each other, and the bus 110 may carry communications (e.g., control messages) between the other components.

The processor 120 may receive a command from other component (e.g., the memory 130, the input/output interface 140, the display 150, the communication interface 160, or the web engine module 170) through, e.g., the bus 110, may interpret the received command, and may execute computation or data processing according to the interpreted command.

The memory 130 may store a command or data received from other component (e.g., the input/output interface 140, the display 150, the communication interface 160, or the web engine module 170) or a command or data generated by the processor 120 or other component. The memory 130 may retain programming modules including, e.g., a kernel 131, middleware 132, an application programming interface (API) 133, or an application 134. The programming modules may be configured in software, firmware, hardware or a combination of two or more thereof.

The kernel 131 may control or manage system resources (e.g., the bus 110, the processor 120, or the memory 130) used to execute the operation or function implemented in the other programming modules, e.g., the middleware 132, the API 133 or the application 134. The kernel 131 may provide an interface that allows the middleware 132, the API 133, or the application 134 to access the individual components of the electronic device 101 to control or manage the same.

The middleware 132 may function as a relay to allow the API 133 or the application 134 to communicate data with the kernel 131. A plurality of applications 134 may be provided. The middleware 132 may control (e.g., scheduling or load balancing) work requests received from the applications 134, e.g., by allocation the priority of using the system resources of the electronic device 101 (e.g., the bus 110, the processor 120, or the memory 130) to at least one of the plurality of applications 134. In one or more examples, the plurality of applications 134 may include at least one native application designed and built for a particular operating system and hardware. In one or more examples, the plurality of applications 134 may include at least one application downloaded from a remote source such as an app store.

The API 133 is an interface allowing the application 134 to control functions provided from the kernel 131 or the middleware 132. For example, the API 133 may include at least one interface or function (e.g., a command) for filing control, window control, image processing or text control.

According to one or more embodiments, application 134 may comprise, e.g., an SMS/MMS application, an email application, a calendar application, an alarm application, a healthcare application (e.g., an application for measuring exercise amount and/or blood sugar), or an environmental information application (e.g., an application providing atmospheric pressure, moisture, and/or temperature information). In one or more examples, the application 134 may be an application related to information exchange between the electronic device 101 and an external electronic device (e.g., electronic device 104). Examples of the information exchange-related application may include, but is not limited to, a notification relay application for transferring specific information to the external electronic device, or a device management application for managing the external electronic device.

For example, the notification relay application may include a function for relaying notification information generated from other applications of the electronic device 101 (e.g., the SMS/MMS application, email application, health-care application, or environmental information application) to the external electronic device (e.g., the electronic device 104). Additionally or optionally, the notification relay application may receive notification information from, e.g., the external electronic device (e.g., the electronic device 104) and may provide the received notification information to the user. The device management application may manage (e.g., install, delete, or update) at least some functions of the external electronic device (e.g., the electronic device 104) communicating with the electronic device 101 (for example, turning on/off the external electronic device (or some components of the external electronic device) or control of brightness (or resolution) of the display), and/or an application operated in the external electronic device or a service (e.g., call service or message service) provided from the external electronic device.

According to one or more embodiments, the application 134 may include an application designated depending on a property (e.g., type of electronic device) of the external electronic device (e.g., the electronic device 104). For example, when the external electronic device is an MPEG audio layer-3 (MP3) player, the application 134 may include an application related to playing music (e.g., audio property). Similarly, when the external electronic device is a mobile medical device, the application 134 may include an application related to health-care.

According to one or more embodiments, the application 134 may include an application designated to the electronic device 101 or an application received from an external electronic device (e.g., a server 106 or the electronic device 104).

The input/output interface 140 may transfer commands or data input by the user through an input/output device (e.g., a sensor, keyboard and/or touchscreen) to the processor 120, the memory 130, the communication interface 160, and/or the web engine module 170 through, e.g., the bus 110. For example, the input/output interface 140 may provide data regarding the user's touch input through a touchscreen to the processor 120. The input/output interface 140 may output, through the input/output device (e.g., a speaker or display), commands or data received from the processor 120, the memory 130, the communication interface 160, and/or the web engine module 170 through, e.g., the bus 110. For example, the input/output interface 140 may output voice data processed by the processor 120 to the user through a speaker.

The display 150 may display various types of information (e.g., multimedia data or text data) to the user.

The communication interface 160 may interface communication between the electronic device 101 and an external electronic device (e.g., the electronic device 104 or the server 106). For example, the communication interface 160 may be connected with the network 162 via a wired connection or a wireless connection to communicate with the external electronic device. The wireless connection may be made by various radio communication protocols, including, but not limited to, wireless fidelity (Wi-Fi), Bluetooth (BT), near field communication (NFC), global positioning system (GPS), or cellular communication protocols (e.g., long term evolution (LTE), LTE-advanced (LTE-A), code division multiple access (CDMA), wideband CDMA (WCDMA), universal mobile telecommunications service (UMTS), wireless broadband (WiBro) or global system for mobile communications (GSM). The wired connection may be made by various wired communication protocols, including, but not limited to, universal serial bus (USB), high definition multimedia interface (HDMI), recommended standard 232 (RS-232), or plain old telephone service (POTS).

According to an embodiment, the network 162 may be a telecommunication network. The telecommunication network may include a computer network, the Internet, an Internet of things (IoT) network, or a telephone network. According to an embodiment of the disclosure, protocols for communication between the electronic device 101 and the external electronic device (examples of such protocols include, but not limited to, transport layer protocol, data link layer protocol, or physical layer protocol) may be supported by the application 134, the API 133, the middleware 132, the kernel 131, or the communication interface 160.

The web engine module 170 may control the overall operation of the electronic device. According to an embodiment, the web engine module 170 may control the overall operation of a resource manager 202, a resource information list (RIL) manager 203, a cache DB 204, a RIL DB 205, a trace analyzer 206, a decompression engine 207, and a network manager 208 included in the electronic device.

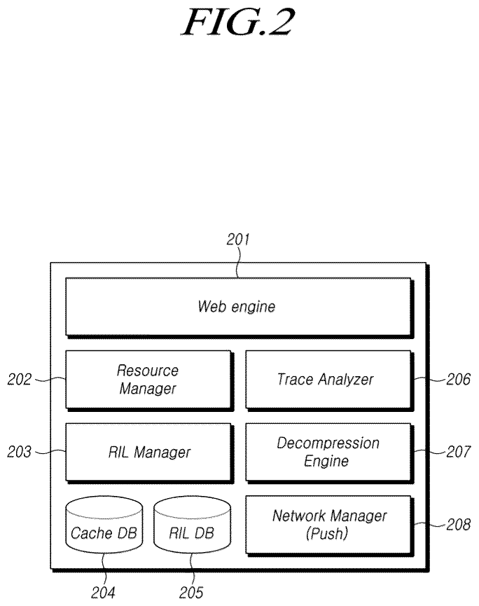

FIG. 2 is a block diagram illustrating a function-specific configuration of an electronic device according to one or more embodiments.

As illustrated in FIG. 2, an electronic device according to various embodiments of the disclosure may include a web engine 201, a resource manager 202, a RIL manager 203, a cache DB 204, a RIL DB 205, a trace analyzer 206, a decompression engine 207, and a network manager 208.

The web engine 201 may control the overall operation of the electronic device. According to an embodiment, the web engine 201 may control the overall operation of the resource manager 202, the RIL manager 203, the cache DB 204, the RIL DB 205, the trace analyzer 206, the decompression engine 207, and the network manager 208 included in the electronic device.

The resource manager 202 may manage resources stored in the electronic device. For example, the resource manager 202 may manage a first resource stored in the disk cache and a second resource included in a cache miss list. For example, the resource manager 202 may perform a validity check when loading the second resource. For example, the resource manager 202 may provide a loaded resource in an idle time upon final loading.

The RIL manager 203 may manage a resource information list. For example, the RIL manager 203 may store a time of requesting a cacheable resource from the server or a time of receiving the cacheable resource. For example, the RIL manager 203 may identify the network distances of a plurality of servers and receive a cacheable resource from a server with the shortest network distance among the servers. For example, the RIL manager 203 may update the resource information list according to the expiration of the validity period or deletion of the resource.

The cache DB 204 may be a database where a cacheable resource is stored. According to an embodiment, the cache DB 204 may store a cacheable resource received from the server. For example, the cache DB 204 may efficiently manage the first resource stored in the disk cache and output information necessary for loading the first resource from the disk cache at the request of the first resource.

The RIL DB 205 may be a database where a resource information list is stored. The resource information list may include various metadata such as the URL, the file format, the file size, cache control information, the validity period, and the last modified date of the resource. For example, the resource information list may include a cache miss list. The cache miss list may include information about the second resource that is not stored in the cache due to a limitation to capacity of the disk cache or a limitation to a specific resource type. For example, the RIL DB 205 may store an updated resource information list based on the resource information list received from the server. For example, the RIL DB 205 may maintain the cache miss list and output information necessary for validation and loading of the second resource during loading the second resource.

When the electronic device uses the web service, the trace analyzer 206 may manage information such as the request time, the request order, and request count for the resource. For example, the trace analyzer 206 may record and analyze the time, order, and number of requests for cacheable resources or uncacheable resources in the web service through a browser. For example, when reusing a web service, the trace analyzer 206 may analyze an idle time to calculate a suitable or optimal time for loading the second resource.

The decompression engine 207 may decompress the compressed data received from the server. For example, the decompression engine 207 may quickly release the compressed second resource during loading and load it into the memory, so that the second resource may be quickly provided to the user during the final loading.

The network manager 208 may perform a function of supporting and managing communication with the server. For example, the network manager 208 may monitor the network state for loading the second resource, perform loading under optimal network conditions, and minimize network load.

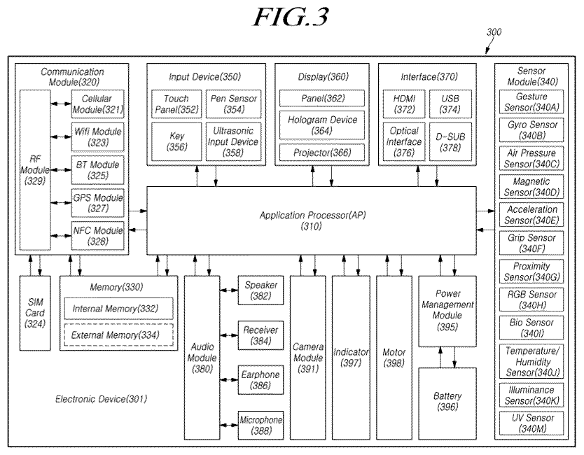

FIG. 3 is a block diagram illustrating an example configuration of an electronic device 301 according to one or more embodiments.

The electronic device 301 may include the whole or part of the configuration of, e.g., the electronic device 101 shown in FIG. 1. In FIG. 3, the electronic device 301 may include one or more application processors (APs) 310, a communication module 320, an SIM (subscriber identification module) card 324, memory 330, a sensor module 340, an input device 350, a display 360, an interface 370, an audio module 380, a camera module 391, a power management module 395, a battery 396, an indicator 397, and/or a motor 398. In an embodiment, a network environment 300 may include the electronic device 301.

The AP 310 may control multiple hardware and software components connected to the AP 310 by running an operating system or application programs, and the AP 2010 may process and compute various data including multimedia data. The AP 310 may be implemented in, e.g., a system on chip (SoC). According to an embodiment of the disclosure, the AP 310 may further include a graphic processing unit (GPU).

The communication module 320 (e.g. the communication interface 160) may perform data communication with other electronic devices (e.g., the electronic device 104 or the server 106) connected with the electronic device 301 (e.g., the electronic device 101) via a network. According to an embodiment of the disclosure, the communication module 320 may include a cellular module 321, a Wi-Fi module 323, a BT module 325, a GPS module 327, an NFC module 328, and a radio frequency (RF) module 329.

The cellular module 321 may provide voice call, video call, text, or Internet services through a communication network (e.g., an LTE, LTE-A, CDMA, WCDMA, UMTS, WiBro, or GSM network). The cellular module 321 may perform identification and authentication on the electronic device in the communication network using, e.g., a subscriber identification module (e.g., the SIM card 324). According to an embodiment of the disclosure, the cellular module 321 may perform at least some of the functions providable by the AP 310. For example, the cellular module 321 may perform at least some of the multimedia control functions.

According to an embodiment, the cellular module 321 may include a communication processor (CP). The cellular module 321 may be implemented in, e.g., an SoC. Although in FIG. 3 the cellular module 321 (e.g., a communication processor), the memory 330, or the power management module 395 are provided separately from the AP 310, the AP 310 may be configured to include at least some (e.g., the cellular module 321) of the above-listed components, according to an embodiment of the disclosure.

According to an embodiment, the AP 310 or the cellular module 321 (e.g., a communication processor) may load commands or data received from a non-volatile memory or other component connected thereto and process the loaded commands or data. The AP 310 or the cellular module 321 may store, in the non-volatile memory, data received from other component(s) or data generated by the other component(s).

The Wi-Fi module 323, the BT module 325, the GPS module 327, or the NFC module 328 may include a process for, e.g., processing data communicated through the module. Although in FIG. 3 the cellular module 321, the Wi-Fi module 323, the BT module 325, the GPS module 327, and the NFC module 328 are shown in their respective separate blocks, at least some (e.g., two or more) of the cellular module 321, the Wi-Fi module 323, the BT module 325, the GPS module 327, and the NFC module 328 may be included in a single integrated circuit (IC) or an IC package. For example, at least some of the processors respectively corresponding to the cellular module 321, the Wi-Fi module 323, the BT module 325, the GPS module 327, and the NFC module 328 (e.g., the communication processor corresponding to the cellular module 321 and the Wi-Fi processor corresponding to the Wi-Fi module 323) may be implemented in a single SoC.

The RF module 329 may communicate data, e.g., RF signals. The RF module 329 may include, e.g., a transceiver, a power amp module (PAM), a frequency filter, or a low noise amplifier (LNA). The RF module 329 may further include parts (e.g., conductors or wires) for communicating radio waves in a free space upon performing wireless communication.

Although in FIG. 3 the cellular module 321, the Wi-Fi module 323, the BT module 325, the GPS module 327, and at least one of the NFC module 328 share a single RF module 329, the cellular module 321, the Wi-Fi module 323, the BT module 325, the GPS module 327, or the NFC module 328 may communicate RF signals through a separate RF module(s).

The SIM card 324 may include a subscriber identification module, and the SIM card 2024 may be inserted into a slot formed at a predetermined position of the electronic device. The SIM card 324 may contain unique identification information (e.g., an integrated circuit card identifier (ICCID) and/or subscriber information (e.g., an international mobile subscriber identity (IMSI)).

The memory 330 (e.g., the memory 130) may include an internal memory 332 or an external memory 334. The internal memory 332 may include at least one of, e.g., a volatile memory (e.g., a DRAM (dynamic RAM), an SRAM (static RAM), an SDRAM (synchronous dynamic RAM), etc.) or a non-volatile memory (e.g., an OTPROM (one time programmable ROM), a PROM (programmable ROM), an EPROM (erasable and programmable ROM), an EEPROM (electrically erasable and programmable ROM), a mask ROM, a flash ROM, a NAND flash memory, or a NOR flash memory).

According to an embodiment of the disclosure, the internal memory 332 may be a solid state drive (SSD). The external memory 334 may include a flash drive, e.g., a compact flash (CF) memory, a secure digital (SD) memory, a micro-SD memory, a min-SD memory, an extreme digital (xD) memory, and/or a memory stick™. The external memory 334 may be functionally connected with the electronic device 301 via various interfaces. According to an embodiment, the electronic device 301 may further include a storage device (or storage medium) such as a hard disk drive.

The sensor module 340 may measure a physical quantity or detect an operational stage of the electronic device 301, and the sensor module 2040 may convert the measured or detected information into an electrical signal. The sensor module 340 may include at least one of, e.g., a gesture sensor 340A, a gyro sensor 340B, an air pressure sensor 340C, a magnetic sensor 340D, an acceleration sensor 340E, a grip sensor 340F, a proximity sensor 340G, a color sensor 340H such as an red-green-blue (RGB) sensor, a bio sensor 340I, a temperature/humidity sensor 340J, an illuminance sensor 340K, or an ultra violet (UV) sensor 340M.

Further, the sensor module 340 may include one or more sensors, e.g., an E-nose sensor, an electromyography (EMG) sensor, an electroencephalogram (EEG) sensor, an electrocardiogram (ECG) sensor, an infrared (IR) sensor, an iris sensor, and/or a finger print sensor. The sensor module 340 may further include a control circuit for controlling at least one or more of the sensors included in the sensing module.

The input unit 350 may include a touch panel 352, a (digital) pen sensor 354, a key 356, or an ultrasonic input device 358. The touch panel 352 may recognize touch inputs in at least one of capacitive, resistive, infrared, or ultrasonic methods. The touch panel 352 may further include a control circuit. With the capacitive method, physical contact or proximity detection may be possible. The touch panel 352 may further include a tactile layer. In this regard, the touch panel 352 may provide the user with a tactile response.

The (digital) pen sensor 354 may be implemented in a way identical or similar to, e.g., the way a touch input of a user is received, or by using a separate sheet for recognition. The key 356 may include, e.g., a physical button, optical key and/or key pad. The ultrasonic input device 358 may use an input tool that generates an ultrasonic signal, allowing the electronic device 301 to detect the ultrasonic signal through the microphone 388 and determine the corresponding data, and may function as a wireless recognition device. According to an embodiment, the electronic device 301 may receive the user's input from an external electronic device (e.g., a network, computer, or server) connected with the electronic device 2301 using the communication module 320.

The display 360 (e.g., the display 150) may include a panel 362, a hologram device 364, or a projector 366. The panel 362 may be, e.g., a liquid crystal display (LCD), active matrix organic light emitting diodes (AMOLEDs). The panel 362 may be implemented to be flexible, transparent, or wearable. The panel 362 may also be incorporated with the touch panel 352 in a module. The hologram device 364 may make three dimensional (3D) images (holograms) in the air by using light interference. The projector 366 may display an image by projecting light onto a screen. The screen may be, for example, located inside or outside of the electronic device 301. In accordance with an embodiment, the display 360 may further include a control circuit to control the panel 362, the hologram device 364, and/or the projector 366.

The interface 370 may include, e.g., a high definition multimedia interface (HDMI) 372, a universal serial bus (USB) 374, an optical interface 376, and/or a D-subminiature (D-sub) 378. The interface 370 may be included in e.g., the communication interface 160 shown in FIG. 1. Additionally or alternatively, the interface 370 may include a mobile high-definition link (MHL) interface, a secure digital (SD) card/multimedia card (MMC) interface, and/or infrared data association (IrDA) standard interface.

The audio module 380 can convert sound to electrical signals, or vice versa. The audio module 380 may perform various processes (e.g., encoding or decoding) relating to converting a sound wave and audio signal to an electric signal or vice versa. At least a part of the audio module 380 may be included in e.g., the input/output interface 140 as shown in FIG. 1. The audio module 380 may process sound information input or output through e.g., a speaker 382, a receiver 384, an earphone 386, and/or a microphone 388.

The camera module 391 may be a device for capturing still images and videos. The camera module 391 may include one or more image sensors (e.g., front and back sensors), a lens, an Image Signal Processor (ISP), and/or a flash (e.g., an LED or xenon lamp).

The power manager module 395 may manage power of the electronic device 301. The power manager module 395 may comprise, e.g., a power management integrated circuit (PMIC), a charger integrated circuit (IC), and/or a battery or fuel gauge.

The PMIC may be mounted on e.g., an integrated circuit (IC) or an SOC semiconductor. A charging method may be classified into wired and wireless charging methods. The charger IC may charge a battery and prevent overvoltage or overcurrent from being induced from a charger. According to an embodiment, the charger IC may be used in at least one of a cable charging method or a wireless charging method. The wireless charging method may include, e.g., a magnetic resonance method, a magnetic induction method, and/or an electromagnetic wave based method, and an additional circuit for wireless charging, such as a coil loop, a resonance circuit, and/or a rectifier may be added.

The battery gauge may measure an amount of remaining power of the battery 396, and/or a voltage, a current, and/or a temperature during charging.

The battery 396 may save or generate electricity, and supply power to the electronic device 301 with the saved or generated electricity. The battery 396 may include, e.g., a rechargeable battery and/or a solar battery.

The indicator 397 may indicate a particular state of the electronic device 301 or a part of the electronic device (e.g., the AP 310), the particular state including, e.g., a booting state, a message state, or charging state. The motor 398 may convert an electric signal to a mechanical vibration. A processing unit for supporting a mobile TV, such as a graphic processing unit (GPU) may be included in the electronic device 301. The processing unit for supporting a mobile TV may process media data conforming to a standard for Digital Multimedia Broadcasting (DMB), Digital Video Broadcasting (DVB), and/or media flow.

According to one or more embodiments, the electronic device 301 may manage resources not stored in the disk cache as a cache miss list and preload the resources in an idle time, thereby optimizing the loading performance of a web service. The electronic device 301 may minimize network requests required for a web service and provide a fast response to the user.

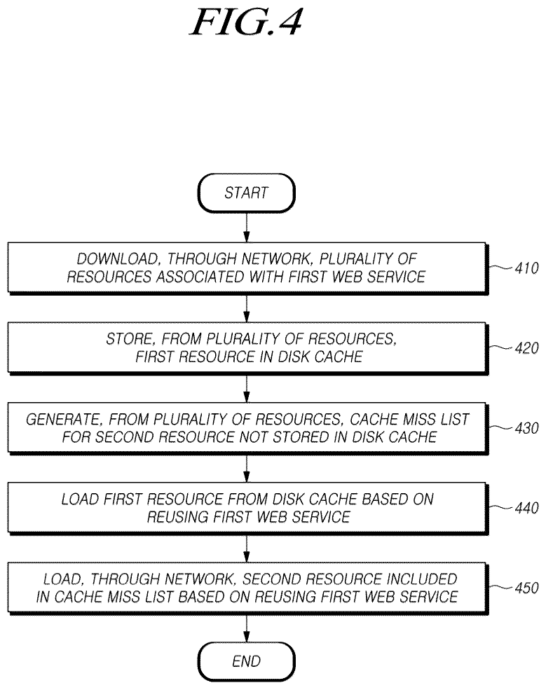

FIG. 4 is a flowchart illustrating operations of an electronic device (e.g., the electronic device (301)) according to one or more embodiments.

In FIG. 4, the electronic device 301 may store a cacheable resource in a disk cache and, when accessing a web service, load the resource from the disk cache. The electronic device 301 may manage a cacheable resource not stored in a disk cache as a cache miss list, and, when accessing a web service, load the resource through a network. For example, the electronic device 301 may manage cacheable resources not stored in the disk cache as a cache miss list and load the resources in an idle time.

In an embodiment, the electronic device 301 may download, through a network, a plurality of resources associated with a first web service (operation 410), store, from the plurality of resources, a first resource in a disk cache (operation 420), generate, from the plurality of resources, a cache miss list for a second resource not stored in the disk cache (operation 430), load the first resource from the disk cache based on reusing the first web service (operation 440), and load, through the network, the second resource included in the cache miss list based on reusing the first web service (operation 450).

In an embodiment, the web service may include at least one of a web application or a web browser. The electronic device 301 may utilize the web service through the network. For example, the electronic device 301 may execute the web application through the network. For example, the electronic device 301 may access the web browser through the network.

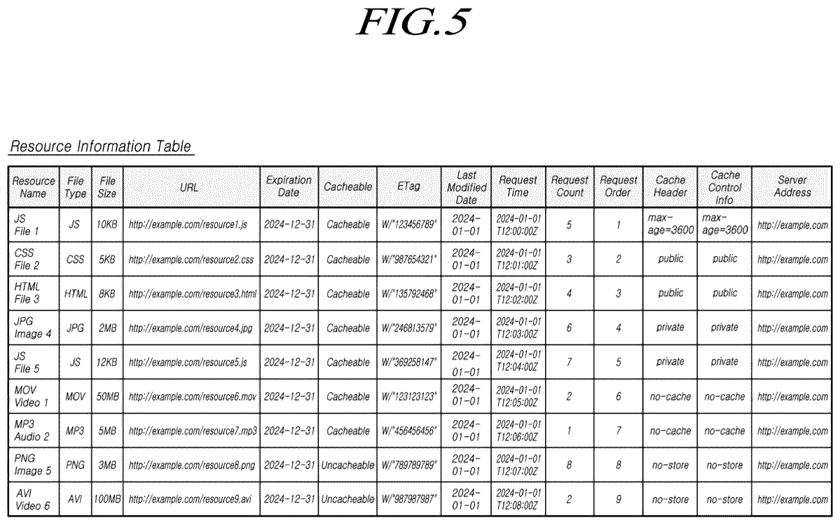

According to an example, in operation 410, the electronic device 301 may download, through the network, a plurality of resources associated with the first web service. FIG. 5 is referred to explain the plurality of resources.

FIG. 5 is an example view illustrating a resource information table received by an electronic device (e.g., the electronic device (301)) according to one or more embodiments.

In FIG. 5, the electronic device 301 may receive, from a server, a resource information table for a plurality of resources associated with a web service. The plurality of resources may be necessary for use of the web service. The resource information table may be a data structure including meta information of the plurality of resources (e.g., all resources necessary for use of the web service). The resource information table may include at least one of resource name, file format, file size, uniform resource locator (URL), validity period, cache availability information, E-Tag, last modified date, request time, request count (e.g., request number), request order, cache header, cache control information, or server address.

For example, the electronic device 301 may access the server through the URL of the first web service. The electronic device 301 may transmit to the server a hypertext transfer protocol (HTTP) request for a resource necessary for executing a web service. The electronic device 301 may receive various types of cacheable resources in various forms, such as HTML, CSS, JavaScript files, images, fonts, audio and/or video files from the server.

The plurality of resource may include a cacheable resource and an uncacheable resource. The cacheable resource may be a resource that is stored in the disk cache and may be quickly loaded locally (e.g., from the disk cache) without re-downloading through the network at a future request. The uncacheable resource may be a resource that may not be stored in the disk cache due to its high variability or is designated not to be cached according to the settings of the server. For example, the electronic device 301 may identify the cacheable resource and the uncacheable resource among resources based on the cache availability information included in the resource information table.

The electronic device 301 may download a resource and manage the downloaded resource, in view of the characteristics of the cacheable resource. For example, the electronic device 301 may download and store the URL, file format, file size, and/or cache control information of each resource. For example, the electronic device 301 may use the decompression engine 207 to decompress the compressed resource received from the server and store the decompressed resource.

According to an example, in operation 420, the electronic device 301 may store, from the plurality of resources, the first resource in the disk cache. The electronic device 301 may store the first resource from the cacheable resources in the disk cache. For example, the electronic device 301 may store the first resource downloaded through the network, thereby quickly loading the first resource locally (e.g., from the disk cache) at the request for the same resource in the future.

The electronic device 301 may store at least one of the URL, the file size, the file format, the cache control information, the validity period, or the last modified date of the first resource in the disk cache. For example, the URL may be information identifying the position of the resource. For example, file size and file format may be used to manage the storage space of resources and to determine a processing method during loading. For example, the cache control information may be used to manage the cache validity of the resource. For example, the validity period and the last modified date may be used to maintain the state of the resource or to update the resource.

For example, the electronic device 301 may periodically examine the validity of the first resource stored in the disk cache through the resource manager 202, and update or delete the first resource whose validity period is expired. Further, the electronic device 301 may optimize loading performance by managing metadata of the first resource stored in the disk cache using the cache DB 204.

In an embodiment, the electronic device 301 may identify that the free capacity of the disk cache is smaller than or equal to a threshold capacity. The electronic device 301 may determine that, from the plurality of resources, the second resource is a resource that is not stored in the disk cache based on at least one of the resource size and the resource format. The electronic device 301 may determine that, from the cacheable resources, the second resource is a resource that is not stored in the disk cache based on at least one of the resource size and the resource format.

The electronic device 301 may store the first resource in the disk cache while simultaneously identifying the second resource that is not stored in the disk cache. For example, resources with a large file size or a specific format (e.g., high-resolution video files and/or high-volume image files) may be unsuitable for storage in the disk cache. The second resource may be a cacheable resource that is designated to be cached according to the settings of the server, but may not be stored in the disk cache in view of the resource size and/or the resource format.

For example, the electronic device 301 may monitor the current usage of the disk cache (e.g., cache capacity) and detect a time when the cache capacity falls below a predefined threshold. At the time when the cache capacity falls below the predefined threshold, the electronic device 301 may determine a resource whose size or format does not meet the limitation condition of the disk cache as the second resource that may not be stored in the disk cache.

Further, the electronic device 301 may set a specific resource not to be stored in the cache based on the cache control information. For example, the electronic device 301 may determine that a resource including the indicator ‘no-store’ or ‘no-cache’ in the cache control information as the second resource that may not be stored in the disk cache.

According to an example, in operation 430, the electronic device 301 may generate, from the plurality of resources, a cache miss list for a second resource not stored in the disk cache. The electronic device 301 may generate, from the cacheable resources, the cache miss list for the second resource not stored in the disk cache. For example, the electronic device 301 may identify the second resource not stored in the disk cache based on a capacity limit of the disk cache or a specific resource format and generate a cache miss list including information about the second resource.

The cache miss list may include at least one of the URL, the validity period, the request time, request count, the request order, the cache header, cache control information, or the server address of the second resource. For example, the URL may indicate the position of the second resource. For example, the validity period may define a period for ensuring up-to-dateness of the second resource. For example, the request time and request count may refer to the frequency of use of the second resource. For example, the request order may be used to determine the priority of the second resource. For example, the cache header and the cache control information may define a cache policy of the second resource. For example, the server address may be used to identify the position of the server providing the second resource.

The electronic device 301 may store the cache miss list including information about the second resource. For example, the electronic device 301 may store the cache miss list in the RIL DB 205. For example, the RIL DB 205 may maintain the cache miss list and output information necessary for validation and loading of the second resource during loading of the second resource.

According to an example, in operation 440, the electronic device 301 may load the first resource from the disk cache based on reusing the first web service. For example, the electronic device 301 may identify reuse of the first web service and identify the disk cache to load the resource of the first web service. For example, the electronic device 301 may identify re-execution of the first web application. For example, the electronic device 301 may identify reconnection to the first web browser. For example, the disk cache may include the first resource stored when the first web service is previously used. For example, when re-executing the first web application or reconnecting to the first web browser, the electronic device 301 may quickly load the first resource needed to load the page from the disk cache without a network request.

When loading the first resource, the electronic device 301 may check the validity of the first resource stored in the disk cache. The validity check may be performed based on at least one of the URL, the validity period, the E-Tag, or the last modified date of the resource. For example, when the validity period of the first resource is not expired and the E-Tag value matches that of the server, the electronic device 301 may determine that the first resource is valid. For example, when it is determined that the first resource is valid, the electronic device 301 may load the valid first resource from the disk cache. In one or more examples, a validity check may be passed when a condition is satisfied such as at least one URL matching a designated URL, the validity check is performed within a validity period, a resource includes an E-Tag, or the last modified date of a resource is before a predetermined date.

The electronic device 301 may manage the first resource loaded from the disk cache via the resource manager 202. For example, the electronic device 301 may load the first resource after decompressing the compressed first resource using the decompression engine 207. As such, when reusing the first web service, the electronic device 301 may minimize network requests and optimize resource loading performance by loading the first resource from the disk cache.

According to an example, in operation 450, the electronic device 301 may load, through the network, the second resource included in the cache miss list based on reusing of the first web service. For example, the electronic device 301 may detect the time where the user re-executes the first web application or reconnects to the first web browser, and may identify the second resource that needs to be loaded by referring to the cache miss list.

In an embodiment, the electronic device 301 may load the second resource through the network during an idle time. For example, the electronic device 301 may load the second resource through the network independently from loading the first resource, and quickly perform final-loading using the loaded second resource when the second resource is needed to load a certain page in the first web service. In one or more examples, the electronic device 301 may load the second resource before a web service is executed or displayed on the electronic device 301. In one or more examples, the electronic device 301 may load the second resource through the network independently regardless of the start and/or completion of loading of the first resource.

In an embodiment, the electronic device 301 may perform a validity check on the second resource included in the cache miss list based on the reuse of the first web service. For example, the electronic device 301 may check the validity of the second resource corresponding to the cache miss list before loading the second resource. The electronic device 301 may verify the validity of the second resource based on at least one of the URL, the validity period, the E-Tag, or the last modified date of the second resource.

For example, the electronic device 301 may analyze metadata of each second resource in the cache miss list to identify whether the second resource is up-to-date. The electronic device 301 may determine via the validity check whether the second resource included in the cache miss list remains up-to-date or whether update is required.

For example, the electronic device 301 may check the validity period of the second resource to determine whether the corresponding resource is still valid or needs to be updated. When the validity period of the second resource is expired, the electronic device 301 may newly download and update the second resource.

For example, the electronic device 301 may check the consistency of the second resource using the entity tag (E-Tag). The E-Tag is a unique identifier representing the version of the second resource. The electronic device 301 may determine whether the second resource has been changed by comparing the E-Tag provided by the server with the E-Tag included in the cache miss list.

The last modified date indicates the date when the second resource was last changed. The electronic device 301 may identify whether the second resource has been changed based on the last modified date. For example, the electronic device 301 may determine whether the second resource has been changed by comparing the last modified date provided by the server with the last modified date stored in the current cache.

The cache control information is information defining a caching policy of the second resource, and may include an HTTP header such as Cache-Control, Expires, and/or Pragma. The electronic device 301 may identify the cache state of the second resource or update the second resource, based on the cache control information.

In an embodiment, the electronic device 301 may identify reusing the first web service and load the second resource included in the cache miss list in an idle time where the CPU usage is smaller than or equal to a reference usage. In one or more examples, the idle time may be determined when the CPU usage is smaller than or equal to the reference usage for a predetermined period time.

For example, the electronic device 301 may detect the time when the user reuses the first web service and monitor CPU usage for the currently running process. When reaching an idle time where the CPU usage is equal to or smaller than a predefined reference usage, the electronic device 301 may identify the second resource requiring loading in view of the cache miss list.

In an embodiment, the electronic device 301 may load the second resource based on identifying the second resource. For example, the electronic device 301 may load the second resource based on at least one of the URL, validity period, request time, request count, request order, cache header, cache control information, or server address of the second resource stored in the cache miss list. As such, the electronic device 301 may utilize the idle time to load the second resource, thereby optimizing or improving system resource use and minimizing or reducing network load.

In an embodiment, the electronic device 301 may monitor the network state through the network manager 208 and load the second resource under an optimal network condition. For example, the electronic device 301 may load the second resource when the network link speed (e.g., reception speed or transmission speed) is a reference network speed or more. Accordingly, the electronic device 301 may avoid network congestion that may occur during the loading process and enhance resource loading performance.

In an embodiment, the electronic device 301 may load the second resource from the cache miss list through a separate thread independently of the process of loading the first resource from the disk cache.

For example, when reusing the first web service, the electronic device 301 performs an operation of loading the first resource from the disk cache. Independently of loading the first resource, the electronic device 301 may generate a separate thread to load the second resource based on the cache miss list.

For example, the separate thread may be configured to load the second resource in an idle time where the CPU usage is smaller than or equal to the reference usage. As such, the electronic device 301 may efficiently load the second resource in the background without affecting the performance of the main process. In one or more examples, the first resource and the second resource may be loaded via separate independent processes that may be executed in parallel.

In an embodiment, the electronic device 301 may advantageously reduce a network burden resulting from the loading of the second resource by setting the loading priority of the second resource to a threshold priority or lower, based on at least one of the validity period, request time, request count, or request order of the second resource. For example, the electronic device 301 may analyze metadata of each second resource included in the cache miss list to preferentially load the second resource with an imminent validity period or a high frequency of requests.

The electronic device 301 may determine the priority of each resource based on information such as the validity period, request time, request count, and/or request order of the second resource stored in the cache miss list. For example, the resources with an imminent validity period may need to be loaded quickly. For example, resources with a high frequency of requests may have a high priority to enhance the user experience. Further, the priority of the resource may be changed based on the request time and the request order.

The electronic device 301 may efficiently manage the network load based on priority by loading the second resource set to have (e.g., assigned) a priority below the threshold priority. For example, the network manager 208 may avoid network congestion and optimize or improve resource loading performance by monitoring the network state and loading the second resource under suitable or optimal conditions.

In an embodiment, the electronic device 301 may set a loading priority based on at least one of the validity period, request time, request count, or request order of the second resource, and efficiently load the second resource based on the loading priority while reducing the network burden.

In an embodiment, when loading a certain page in the first web service, the electronic device 301 may identify whether the second resource is loaded. For example, when the second resource is loaded by being pre-downloaded in an idle time, the electronic device 301 may quickly access the second resource.

When the loaded second resource is present, the electronic device 301 may immediately final-load the second resource on the first web service without a network request.

When the loaded second resource is not present, the electronic device 301 may download the second resource through the network. For example, the electronic device 301 may download the second resource on the first web service through a network request. According to an embodiment, the electronic device 301 may store the downloaded information about the second resource in the cache miss list.

As such, the electronic device 301 may provide a quick and smooth web service use experience to the user by loading the second resource in the idle time and immediately final-loading the second resource when page loading is required.

In one embodiment, the electronic device 301 may provide the first web service using the first resource and the second resource. The electronic device 301 may load the first resource from the disk cache and simultaneously, in parallel, and/or independently load the second resource through the network to utilize the first web service.

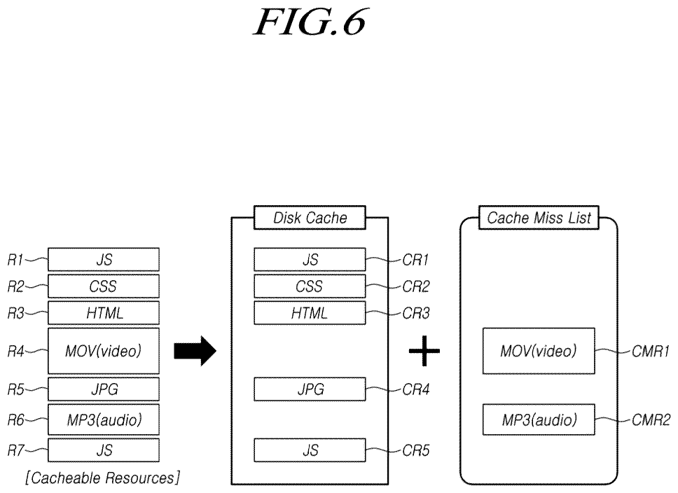

FIG. 6 is a view illustrating a method for storing a cacheable resource by an electronic device 301 according to one or more embodiments.

In FIG. 6, an electronic device 301 may identify a cacheable resource and an uncacheable resource. The electronic device 301 may store a first resource among the cacheable resource in the disk cache. The electronic device 301 may store a second resource among the cacheable resource in the cache miss list. The electronic device 301 may efficiently manage the first resource and the second resource using the disk cache and the cache miss list.

In an embodiment, the electronic device 301 may download various resources necessary for the web service through the network. The resources may be classified into cacheable resources and uncacheable resources. The cacheable resource may be a resource that may be stored in the disk cache and may be quickly loaded locally (e.g., from the disk cache) without re-downloading through the network at a future request. The uncacheable resource may be a resource that may not be stored in the disk cache because the resource is highly variable or is designated not to be cached according to the settings of the server.

The electronic device 301 may analyze the downloaded resource to identify the cacheable resource and the uncacheable resource. For example, the cacheable resources (e.g., R1, R2, R3, R4, R5, R6, and/or R7) may include at least one of a JavaScript file, a CSS file, an HTML file, a JPG image file, a MOV video file, or an MP3 audio file.

The electronic device 301 may store the first resource among cacheable resources in the disk cache. For example, the electronic device 301 may store the first resource downloaded through the network, thereby quickly loading the first resource from the local disk cache at the same request in the future. For example, the first resources (e.g., CR1, CR2, CR3, CR4, and/or CR5) may include at least one of a JavaScript file, a CSS file, an HTML file, or a JPG image file. The electronic device 301 may store in the disk cache at least one of the URL, the file size, the file format, cache control information, the validity period, or the last modified date of the first resource.

The electronic device 301 may generate the cache miss list for the second resource not stored in the disk cache among the cacheable resources. For example, the electronic device 301 may identify the second resource based on the capacity limit of the disk cache or a specific resource format and add the corresponding information to the cache miss list. For example, the second resources (e.g. CMR1 and CMR2) may include at least one of an MOV video file or an MP3 audio file. The cache miss list may include at least one of the URL, the validity period, the request time, the request count, the request order, the cache header, the cache control information, or the server address of the second resource.

The electronic device 301 may efficiently manage the disk cache and the cache miss list. For example, the electronic device 301 may periodically examine the validity of the first resource and/or second resource stored in the disk cache through the resource manager 202, and update or delete the first resource and/or second resource whose validity period is expired. Further, the electronic device 301 may optimize loading performance by systematically managing metadata of the first resource and/or second resource stored in the disk cache using the cache DB 204.

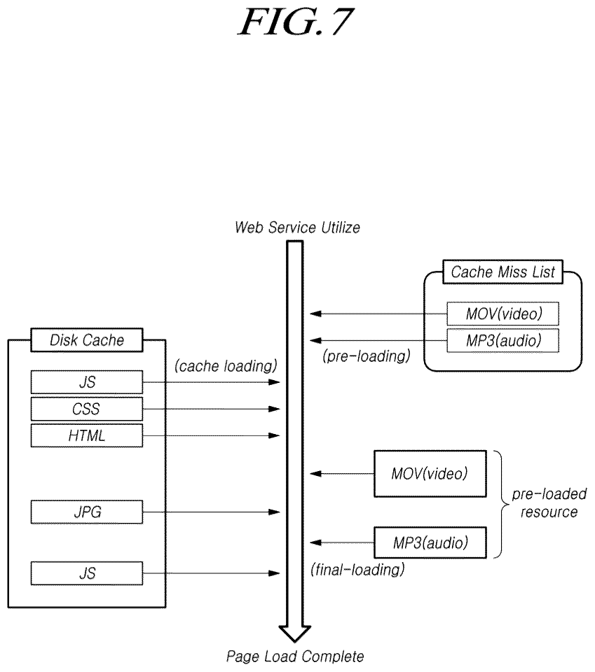

FIG. 7 is a view illustrating a process of loading a web service by an electronic device (e.g., the electronic device 301) according to one or more embodiments.

In FIG. 7, the electronic device 301 may load the first resource from the disk cache when reusing a first web service. When reusing the first web service, the electronic device 301 may load the second resource using the cache miss list. The electronic device 301 may provide a quick and smooth web service use experience to the user by final-loading the second resource after loading the second resource.

The electronic device 301 may load the first resource from the disk cache based on the reuse of the first web service. For example, the electronic device 301 may identify re-executing the first web application, or reconnecting to the first web browser, and search resources necessary for page loading in the disk cache. For example, the disk cache may include the previously stored first resource. The electronic device 301 may quickly load resources locally without a network request using the disk cache. The electronic device 301 may load a valid first resource from the disk cache after performing a validity check based on the URL, validity period, E-Tag, and/or last modified date of the first resource.

The electronic device 301 may load the second resource included in the cache miss list based on the reuse of the first web service. For example, the electronic device 301 may identify re-execution of the first web application or reconnection to the first web browser, and identify the second resource requiring loading in view of the cache miss list. For example, the electronic device 301 may pre-download through the network the second resource included in the cache miss list during an idle time. For example, the electronic device 301 may load the second resource, such as an MOV video file CMR1 or an MP3 audio file CMR2. The electronic device 301 may load the valid resource after checking the URL, validity period, E-Tag, and/or last modified date of the second resource through a validity check.

As illustrated in FIG. 7, the electronic device 301 may load the second resource from the cache miss list through a separate thread independently of the process of loading the first resource from the disk cache. For example, when reusing the first web service, the electronic device 301 may perform an operation of loading the first resource from the disk cache while simultaneously generating a separate thread to load the second resource. The separate thread may be configured to load the second resource in an idle time where the CPU usage is smaller than or equal to the reference usage. By performing preloading through the separate thread, the electronic device 301 may efficiently load the second resource in the background without affecting the performance of the main process.

When loading a certain page in the first web service, the electronic device 301 may identify whether the second resource has been loaded. When the loaded second resource is present, the electronic device 301 may immediately final-load the second resource without a network request. As such, the electronic device 301 may provide a quick and smooth web service use experience to the user by loading the second resource in the idle time and immediately final-loading the second resource when page loading is required.

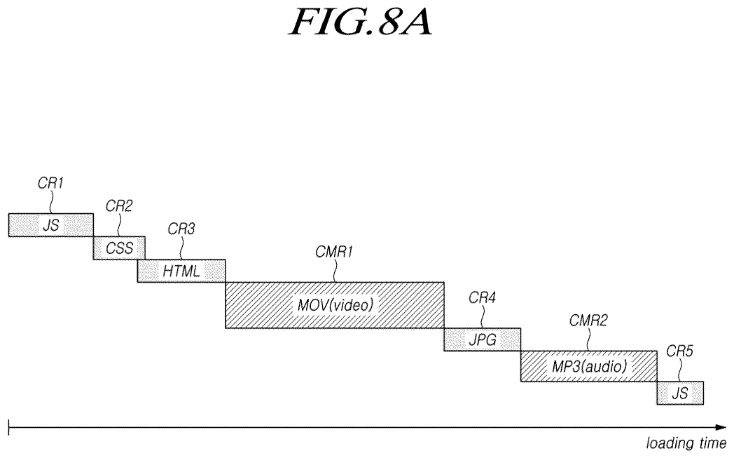

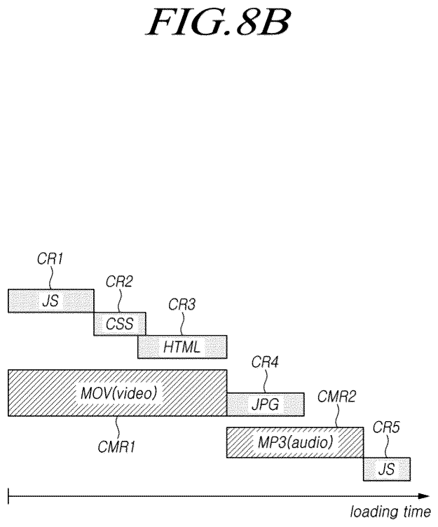

FIGS. 8A and 8B are views illustrating comparison between web service loading times by an electronic device (e.g., the electronic device 301) according to one or more embodiments.

In FIGS. 8A and 8B, the electronic device 301 may independently load the first resource and the second resource through separate threads and minimize the network burden through priority-based loading, thereby reducing the overall loading time and enhancing loading efficiency.

As illustrated in FIG. 8A, the conventional web service loading method sequentially downloads and loads all necessary resources when reusing the first web service. For example, in the conventional web service loading method, when a user uses a web service, the user sends an HTTP request to the server through the browser to request necessary resources. In the conventional web service loading method, the user sequentially receives resources from the server and loads the downloaded resources. The conventional web service loading method indicates to the user that the resources are being loaded until they are downloaded, and the user should wait until all of the resources are loaded. For example, in the conventional web service loading method, since all of the resources are loaded sequentially, the loading time may be increased depending on the network state.

As illustrated in FIG. 8B, the electronic device 301 according to the disclosure may reduce the loading time by loading the second resource using the cache miss list. The electronic device 301 may independently perform the processes of loading the first resource and the second resource through separate threads. For example, the first resource may be loaded quickly from the disk cache. For example, the second resource may be loaded in the background through a separate thread.

Further, the electronic device 301 may load the second resource included in the cache miss list based on the priority. The priority may be determined based on at least one of the validity period, request time, request count, or request order of the second resource. The electronic device 301 may efficiently manage the network load based on the priority by performing loading on the second resources set to have a priority below the threshold priority.

In an embodiment, the electronic device 301 may determine whether a validity period of the second resource is expired, and delete from the cache miss list the second resource whose validity period expires. For example, the electronic device 301 may periodically identify the validity period of each second resource included in the cache miss list. The validity period may mean a period during which the second resource may remain valid.

The electronic device 301 may compare the current time with the validity period stored in the cache miss list to determine whether the validity period is expired. For example, when the validity period of the second resource precedes the current time, the electronic device 301 may determine that the validity period of the second resource is expired.

The electronic device 301 may delete from the cache miss list the second resource whose validity period is determined to have expired. For example, the electronic device 301 may identify in the cache miss list the second resource whose validity period is expired and delete the second resource from the cache miss list.

In an embodiment, the electronic device 301 may, when the second resource is deleted from the cache miss list, update the cache miss list by downloading the second resource again through the network based on reusing the first web service.

For example, when the user reuses the first web service, the electronic device 301 may identify whether there is a second resource deleted from the cache miss list. When the deleted second resource is identified, the electronic device 301 may re-download the deleted second resource through the network.

The electronic device 301 may determine whether to store the second resource in the disk cache or in the cache miss list. For example, the electronic device 301 may update the cache miss list with the information about the downloaded second resource.

As such, the electronic device 301 and the resource loading method using the same may manage resources not stored in the disk cache as a cache miss list and load the resources in an idle time, thereby optimizing the loading performance of a web service.

Therefore, the electronic device 301 and the resource loading method using the same may minimize network requests required for a web service and provide a fast response to the user.

However, since this has been described above, no duplicate description is given.

The display device according to various embodiments of the disclosure may be one of various types of electronic devices. The display devices may include, for example, a portable communication device (e.g., a smartphone), a computer device, a portable multimedia device, a portable medical device, a camera, a wearable device, or a home appliance. The display devices according to an embodiment of the disclosure are not limited to the above-described devices.

It should be appreciated that various embodiments of the disclosure and the terms used therein are not intended to limit the technological features set forth herein to particular embodiments and include various changes, equivalents, or replacements for a corresponding embodiment. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program) including one or more instructions that are stored in a storage medium (e.g., internal memory or external memory) that is readable by a machine (e.g., the electronic device). For example, a processor of the machine (e.g., the electronic device) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
memory storing one or more instructions; and
at least one processor operatively coupled to the memory,
wherein the one or more instructions, when executed by the at least one processor, cause the electronic device to:
download, through a network, a plurality of resources associated with a first web service,
store, from the plurality of resources, a first resource in a disk cache,
generate, from the plurality of resources, a cache miss list for a second resource not stored in the disk cache,
load the first resource from the disk cache based on reusing the first web service, and
load, through the network, the second resource included in the cache miss list based on reusing the first web service.

2. The electronic device of claim 1, wherein the second resource is loaded through the network independently of the start or completion of loading the first resource.

3. The electronic device of claim 1, wherein the second resource is loaded during an idle time before the first web service is reused independently of the loading of the first resource.

4. The electronic device of claim 1, wherein the one or more instructions, when executed by the at least one processor, cause the electronic device to:
simultaneously with the loading the first resource, generate a separate thread to load the second resource.

5. The electronic device of claim 1, wherein the one or more instructions, when executed by the at least one processor, cause the electronic device to:
provide the first web service using the first resource and the second resource.

6. The electronic device of claim 1, wherein the one or more instructions, when executed by the at least one processor, cause the electronic device to:
identify that a free capacity of the disk cache is a threshold capacity or less, and
determine that the second resource is a resource not stored in the disk cache based on at least one of a resource size or a resource format of the second resource.

7. The electronic device of claim 1, wherein the one or more instructions, when executed by the at least one processor, cause the electronic device to:
store, in the disk cache, at least one of a uniform resource locator (URL), a file size, a file format, cache control information, a validity period, or a last modified date of the first resource.

8. The electronic device of claim 1, wherein the cache miss list comprises at least one of a uniform resource locator (URL), a validity period, a request time, a request count, a request order, a cache header, cache control information, or server information of the second resource.

9. The electronic device of claim 1, wherein the one or more instructions, when executed by the at least one processor, cause the electronic device to:
identify that the first web service is reused, and
load the second resource included in the cache miss list at an idle time based on determining that a CPU usage is less than or equal to a reference usage.

10. The electronic device of claim 1, wherein the one or more instructions, when executed by the at least one processor, cause the electronic device to:
load the second resource from the cache miss list through a separate thread independently from a process of loading the first resource from the disk cache.

11. The electronic device of claim 1, wherein the one or more instructions, when executed by the at least one processor, cause the electronic device to:
reduce a network burden resulting from loading of the second resource by setting a loading priority of the second resource to a threshold priority or lower based on at least one of a validity period, a request time, a request count, or a request order of the second resource.

12. The electronic device of claim 1, wherein the one or more instructions, when executed by the at least one processor, cause the electronic device to:
perform a validity check on the second resource included in the cache miss list based on reusing the first web service, and
wherein the validity check includes identifying at least one of a validity period, an E-tag, a last modified date, or cache control information of the second resource.

13. The electronic device of claim 1, wherein the one or more instructions, when executed by the at least one processor, further cause the electronic device to:
determine whether a validity period of the second resource is expired, and
delete from the cache miss list the second resource whose validity period is expired.

14. The electronic device of claim 1, wherein the one or more instructions, when executed the at least one processor, further cause the electronic device to:
based on the second resource being deleted from the cache miss list, download the second resource again through the network based on reusing the first web service to update the cache miss list.

15. A method performed by at least one processor of an electronic device for loading a resource, the method comprising:
downloading, through a network, a plurality of resources associated with a first web service;
storing a first resource from the plurality of resources in a disk cache;
generating a cache miss list for a second resource from the plurality of resources not stored in the disk cache;
loading the first resource from the disk cache based on reusing the first web service; and
loading, through the network, the second resource included in the cache miss list based on reusing the first web service.

16. The method of claim 15, wherein the generating the cache miss list for the second resource comprises:
identifying that a free capacity of the disk cache is a threshold capacity or less; and
determining that the second resource is a resource not stored in the disk cache based on at least one of a resource size or a resource format of the second resource.

17. The method of claim 15, wherein the storing the first resource in the disk cache comprises storing, in the disk cache, at least one of a uniform resource locator (URL), a file size, a file format, cache control information, a validity period, or a last modified date of the first resource.

18. The method of claim 15, wherein the cache miss list comprises at least one of a uniform resource locator (URL), a validity period, a request time, a request count, a request order, a cache header, cache control information, or server information of the second resource.

19. The method of claim 15, wherein the loading the second resource included in the cache miss list through the network comprises:
identifying that the first web service is reused; and
loading the second resource included in the cache miss list at an idle time based on determining that a CPU usage is less than or equal to a reference usage.

20. The method of claim 15, wherein the loading the second resource included in the cache miss list through the network comprises loading the second resource from the cache miss list through a separate thread independently from a process of loading the first resource from the disk cache.
